(19) United States
(12) Patent Application Publication
(10) Pub. No.: US 2004/0029605 A1
(43) Pub. Date: Feb. 12, 2004

(54) Mobile radio with transmission power limitation

(76) Inventor: Tobias Schneider, Muenchen (DE)

Correspondence Address: BELL, BOYD & LLOYD, LLC, P. O. BOX 1135, CHICAGO, IL, 60690-1135, US

(21) Appl. No.: 10/424,355

(22) Filed: Apr. 28, 2003

(30) Foreign Application Priority Data
Apr. 26, 2002 (DE) 102 18 828.9

(51) Int. Cl. H04B 7/00

(52) U.S. Cl. 455/522

(57) ABSTRACT

A mobile radio is disclosed having a transmission level for connection to a cellular, wireless communication network, wherein a maximum transmission power value can be set for the transmission level.

### BACKGROUND OF THE INVENTION

Such a mobile radio is, by way of example, a mobile phone such as is used in the current large-cell and small-cell wireless mobile radio networks based on the GSM and DECT standards.

The population is currently very uncertain about mobile telephony. There is spreading fear of the rays which are emitted by mobile telephones and base stations and of their effect.

The user is currently provided with only indirect influence over the rays which are emitted by his/her mobile telephone. By way of example, the user can attach shields to the unit itself or to the antenna.

If a user and his/her mobile phone are in an area in which the network coverage is very good, or where there is always good reception, then the mobile telephone also transmits at comparatively restricted transmission power. In areas in which coverage is less good, there is not always a good connection to the nearest base station. The mobile phone, therefore, transmits at a higher power or even at maximum power in this case in order to be able to make contact with base stations which are further away. In this case, the burden of rays to which the users are subject when telephoning is at its greatest.

The present invention is, therefore, directed toward reducing the burden of rays to which the mobile phone user is subject.

### SUMMARY OF THE INVENTION

Accordingly, in an embodiment of the present invention, a mobile radio is provided which has a transmission level for connection to a cellular, wireless communication network, wherein a maximum transmission power value can be set for the transmission level of the mobile radio.

Additional features and advantages of the present invention are described in, and will be apparent from the following Detailed Description of the Invention.

### DETAILED DESCRIPTION OF THE INVENTION

The transmission power of the inventive mobile radio can be set to a maximum value using the mobile phone's menu, for example. As such, the user himself/herself can determine the maximum burden of rays which he/she accepts. At the same time, however, the user can still use his/her mobile telephone to make telephone calls in normal environments without loss of contact. In difficult environments, such as in the car or in the mountains, on the other hand, there will often be no reception.

In mobile radios which are already in use, transmission power limitation can be implemented via a software update.

Although the present invention has been described with reference to specific embodiments, those of skill in the art will recognize that changes may be made thereto without departing from the spirit and scope of the present invention as set forth in the hereafter appended claims.

1. A mobile radio having a transmission level for connection to a cellular, wireless communication network, comprising parts for setting a maximum transmission power value for the transmission level of the mobile radio.

2. A mobile radio as claimed in claim 1, wherein the parts for setting the maximum transmission power value include a menu of the mobile radio.

3. A mobile radio as claimed in claim 1, wherein the maximum transmission power value may be set by a user of the mobile radio.

4. A mobile radio as claimed in claim 1, further comprising parts for receiving a software update to the mobile radio, wherein transmission power limitation of the transmission level is implemented via the software update.

5. A method for adjusting a transmission level of a mobile radio, the transmission level for connection to a cellular, wireless communication network, the method comprising the steps of enabling the transmission level of the mobile radio to be adjusted, and setting a maximum transmission power value for the transmission level.

6. A method for adjusting a transmission level of a mobile radio as claimed in claim 5, wherein a menu of the mobile radio is used in the step of setting the maximum transmission power value.

7. A method for adjusting a transmission level of a mobile radio as claimed in claim 5, wherein the step of setting the maximum transmission power value is performed by the user of the mobile radio.

8. A method for adjusting a transmission level of a mobile radio as claimed in claim 5, the method further comprising the step of providing a software update to the mobile radio, wherein transmission power limitation of the transmission level is implemented via the software update.
